(19) United States
(12) Patent Application Publication
(10) Pub. No.: US 2016/0248823 A1
(43) Pub. Date: Aug. 25, 2016

(54) MESSAGING PROTOCOL

(71) Applicant: InvestCloud Inc, Beverly Hills, CA (US)

(72) Inventors: Vicent Sos-Munoz, Beverly Hills, CA (US); John W. Wise, West Hollywood, CA (US); Julian Bowden, London (GB)

(73) Assignee: InvestCloud Inc, Beverly Hills, CA (US)

(21) Appl. No.: 14/630,577

(22) Filed: Feb. 24, 2015

(51) Int. Cl. H04L 29/06; H04L 29/08; H04L 12/58

(52) U.S. Cl. CPC H04L 65/40; H04L 51/046; H04L 67/147

(57) ABSTRACT

A process composes, at a first computing device, a plurality of messages according to a messaging protocol that has a single predetermined immutable message structure for the plurality of messages. Further, the process sends, from the first computing device, the plurality of messages to a second computing device.

### BACKGROUND

1. Field

This disclosure generally relates to the field of computing devices. More particularly, the disclosure relates to messaging protocols for communication between computing devices.

2. General Background

Computing devices typically communicate with each other via various communication protocols, i.e., rules for exchanging information between computing devices, such as Simple Object Access Protocol (“SOAP”). The communication protocols provide a particular format that each computing device is aware of so that the computing devices can send and receive messages to each other according to that format. For instance, a communication protocol defines a syntax, semantics, and synchronization for communication. The syntax refers to the ordering of particular text within a message whereas the semantics refer to the meaning for that text. The synchronization refers to the timing of sending and receiving messages.

Such communication protocols are often utilized in the implementation of a web service, i.e., a function that is provided by a computing device at a network address of a computer network. A typical request is a function call whereby a first computing system requests that a second computing system perform a certain action associated with the function corresponding to the function call. The function call has a signature, i.e., a message structure that provides a framework for the contents of a function call sent from the first computing system to the second computing system. As an example, a SOAP envelope is a signature.

Current configurations typically have different signatures for different function calls. For instance, the first system may have access to thousands of different functions through the second system whereby each function has a different signature when called. In addition, the first system may have thousands of different users that each want to access some or all of those functions.

If a signature or a name of a function call is changed, the code utilized by the first computing system has to be updated and recompiled so that the first computing system calls the corresponding function through a communication protocol correctly on the second computing system. Since the signatures in current configurations are typically different, a significant quantity of recompilations is often necessary for systems updates for computing systems that perform frequent function calls to significant quantities of functions.

Therefore, code development for such computing systems is currently performed in a lockstep manner, e.g., each update to a function name or signature on the second computing system requires an update to the corresponding function call on the first computing system. Otherwise, the first computing system may receive an error message and/or an error without an error message when attempting to call a function on the second computing system according to an old name or old signature. As a result, updates to both the first computing system and the second computing system have to be released concurrently each time a function name or signature is modified. Since computing systems may have many thousands of function calls that each have different signatures, the lockstep approach has resulted in frequent utilization of resources as each update to a function on the second computing system requires an update to the function call on the first computing system to avoid the first computing system having errors in calling such functions.

The lockstep approach is a resource intensive process that requires significant coordination amongst different computing systems on a frequent basis. Thus, previous configurations utilize messaging protocols that are cumbersome and inefficient.

### SUMMARY

In one aspect of the disclosure, a process is provided. The process composes, at a first computing device, a plurality of messages according to a messaging protocol that has a single predetermined immutable message structure for the plurality of messages. Further, the process sends, from the first computing device, the plurality of messages to a second computing device.

In another aspect of the disclosure, a computer program product includes a computer useable storage device having a computer readable program. The computer readable program when executed on a computer causes the computer to compose, at a first computing device, a plurality of messages according to a messaging protocol that has a single predetermined immutable message structure for the plurality of messages. The computer readable program when executed on the computer also causes the computer to send, from the first computing device, the plurality of messages to a second computing device.

In yet another aspect of the disclosure, a process is provided. The process receives, at a first computing device, a first plurality of messages according to a messaging protocol that has a single predetermined immutable message structure for the first plurality of messages. Further, the process performs a plurality of actions based upon content of the first plurality of messages. In addition, the process composes, at the first computing device, a plurality of second messages according to the messaging protocol. The plurality of second messages each has content associated with the plurality of actions. The process also sends, from the first computing device, the plurality of second messages to a second computing device.

In another aspect of the disclosure, a system is provided. The system has a first computing device that composes a first plurality of messages according to a messaging protocol that has a single predetermined immutable message structure for the first plurality of messages and sends the first plurality of messages. Further, the system has a second computing device that receives the first plurality of messages, performs a plurality of actions based upon content of the first plurality of messages, composes a plurality of second messages according to the messaging protocol, and sends the plurality of second messages to the first computing device. The plurality of second messages each has content associated with the plurality of actions.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIGS. 1A and 1B illustrate lockstep configurations that were utilized by previous systems to provide system-to-system interactivity through different messaging protocols.

FIG. 1A illustrates a lockstep configuration that is utilized to provide system-to-system interactivity prior to a system update.

FIG. 1B illustrates a lockstep configuration that is utilized to provide system-to-system interactivity subsequent to a system update.

FIGS. 2A, 2B, and 2C illustrate system configurations that utilize an immutable signature.

FIG. 2A illustrates an immutable signature configuration prior to a system update.

FIG. 2B illustrates an immutable signature configuration subsequent to a system update to the system B.

FIG. 2C illustrates an immutable signature configuration subsequent to a system update to the system A.

FIG. 3 illustrates an example of the components of an immutable signature illustrated in FIGS. 2A, 2B, and 2C.

FIGS. 4A and 4B illustrate examples of different messages that have the same signature, but different data content.

FIG. 4A is an example of an envelope that is utilized to start a new user session.

FIG. 4B is an example of an envelope that is utilized to retrieve a list of assets.

FIG. 5 illustrates a process that may be utilized to generate the immutable signature illustrated in FIGS. 2A, 2B, and 2C.

FIG. 6 illustrates a block diagram of a station or system that generates the immutable signature 201 illustrated in FIGS. 2A, 2B, and 2C.

### DETAILED DESCRIPTION

A method, system, apparatus, and computer program product may be utilized to provide a messaging protocol. The messaging protocol has a predetermined immutable message component. The immutable message component has a permanent message structure. A function name or data fields for a function may change, but the message structure remains unchanged. A system with a significant quantity of functions, e.g., thousands of functions, may utilize a single messaging protocol with the same predetermined immutable message component. In contrast with previous configurations that utilized a different signature for every or almost every function, the method, system, apparatus, and computer program product utilize a single messaging protocol for each system function. Instead of having thousands of function calls with different signatures, a single signature is utilized for all of the function calls. Since the message structure is permanent, recompilations at the binary level are avoided.

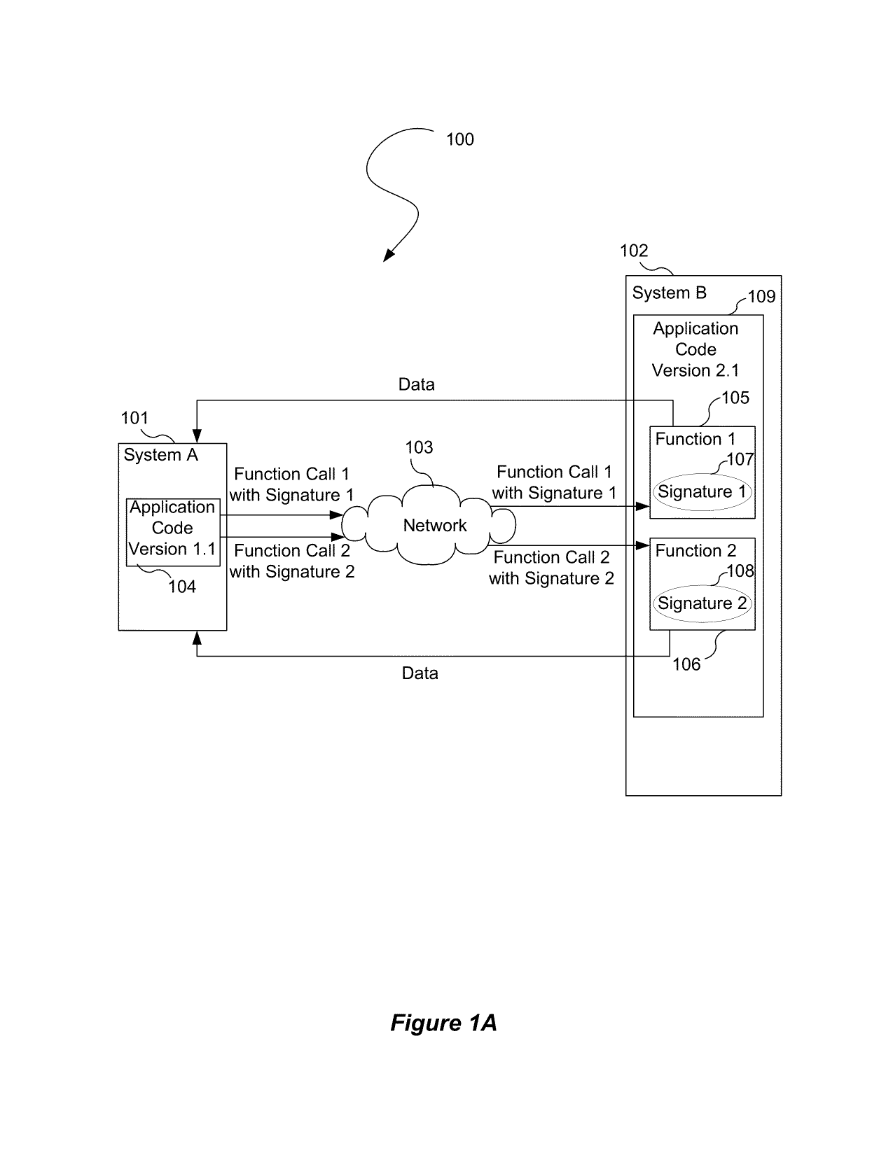

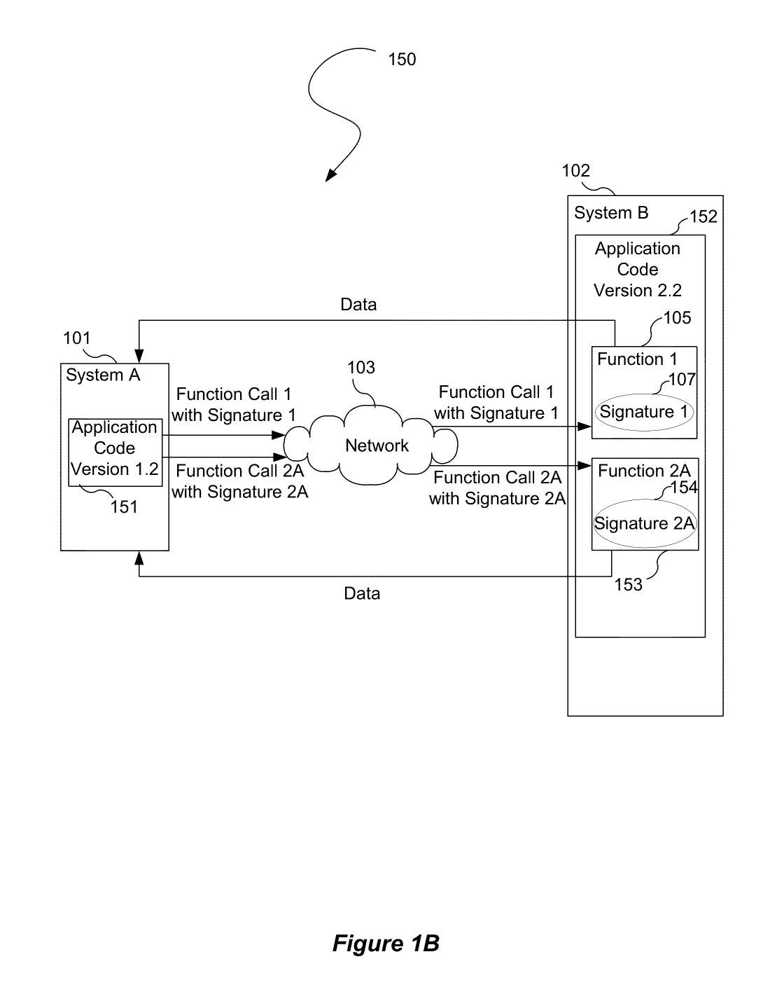

FIGS. 1A and 1B illustrate lockstep configurations that were utilized by previous systems to provide system-to-system interactivity through different messaging protocols. Although such systems typically utilize thousands of different function calls and different messaging protocols, examples of only a few function calls and messaging protocols are provided for ease of illustration.

FIG. 1A illustrates a lockstep configuration 100 that is utilized to provide system-to-system interactivity prior to a system update. The lockstep configuration has a system A 101 and a system B 102. The systems A 101 and B 102 may be implemented by computing devices such as server computers, personal computers, laptop computers, tablet devices, smartphones, etc. The systems A 101 and B 102 communicate through a network 103, e.g., Internet, local area network, wired network, wireless network, etc.

Each of the systems 101 and 102 utilize a particular version of application code. For example, the system A 101 may utilize application code version 1.1 104. The system B 102 may utilize application code version 2.1.

The system A 101 utilizes the application code version 1.1 104 to request various services from the system B 102. The system B 102 provides those services through functions provided by the application code version 2.1 109. The application code version 2.1 109 may provide a significant quantity of functions, but only a few functions are illustrated for ease of illustration. As an example, the application code version 2.1 109 provides function 1 105 and function 2 106. Each function in previous configurations may have a different signature. Therefore, the function 1 105 may have signature 1 107 whereas the function 2 106 may have a signature 2 108 that is different than the signature 1 107.

The system A 101 is aware of the different functions provided by the system B 102. The system A 101 is also aware of the different signatures for those functions so that the system A 101 may send function calls for those different functions according to the different signatures. For instance, the system A 101 sends a message through the network 103 requesting function call 1 for function 1 105 according to the message structure provided by signature 1 107. If the system A 101 wants to request function call 2 for function 2 106, the system A 101 has to send the function call request according to the message structure provided by the signature 2 108.

FIG. 1B illustrates a lockstep configuration 150 that is utilized to provide system-to-system interactivity subsequent to a system update. As an example, a system update to the system B 102 has resulted in application code version 2.2 152 having the function name of the function 2 106 illustrated in FIG. 1A being changed to function 2A 153 illustrated in FIG. 1B. The signature 2 108 illustrated in FIG. 1A has also changed to the signature 2A 154 illustrated in FIG. 1B. If the system A 101 were to utilize the signature 2 108 to request a function call to function 2, an error message and/or an error may result since the signature and function name have changed. The system A 101 would be sending a message according to a message format that the system B 102 did not understand anymore.

Previous configurations attempted to solve this problem by requiring that both a system update to the system A 101 and the system B 102 be released together. In other words, the update for the application code version 2.2 152 could not be released until the update for the application code version 1.2 151 was released. As a result, code developers that updated the system B 102 had to inform code developers for the system A 101 of the update to the system B 102 and wait for the code developers for the system A 101 to generate code for the system A 101 so that both updates, e.g., the application code version 1.2 151 and the application code version 2.2 152 could be released together.

Such a lockstep approach has led to significant inefficiency in the code development process. Code developers for one system have to wait on system updates for code developers for another system to generate code. As many systems have thousands of different functions, the requirement for the lockstep release of updates is often cumbersome and resource intensive for perform for updates to many functions.

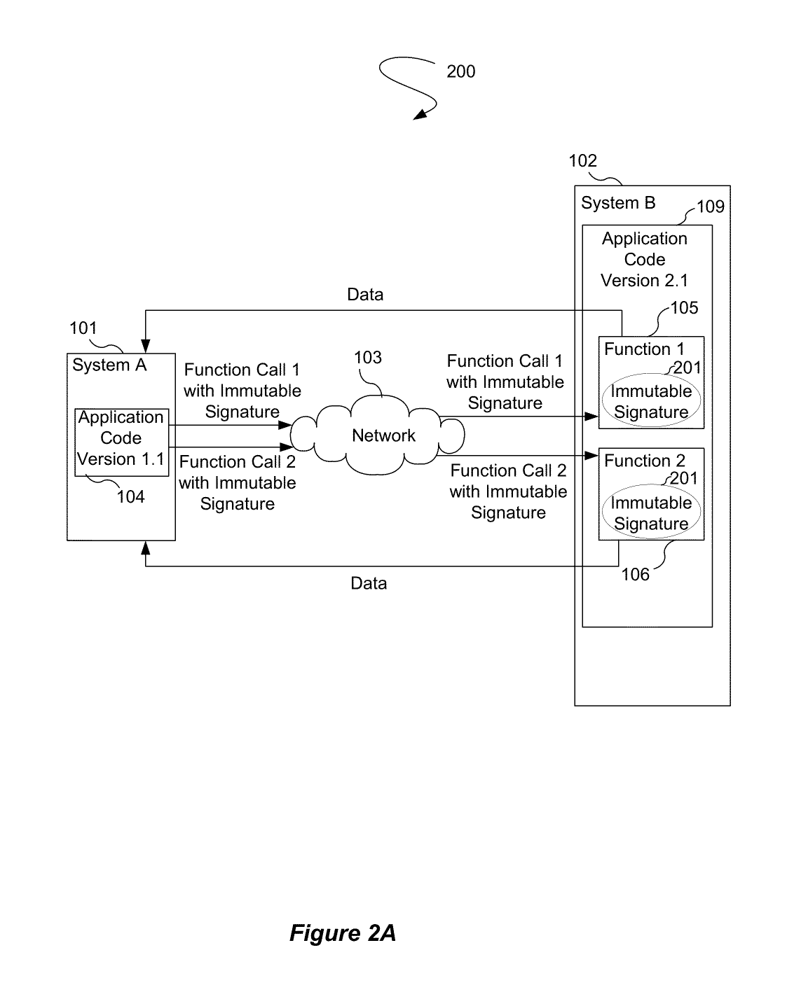

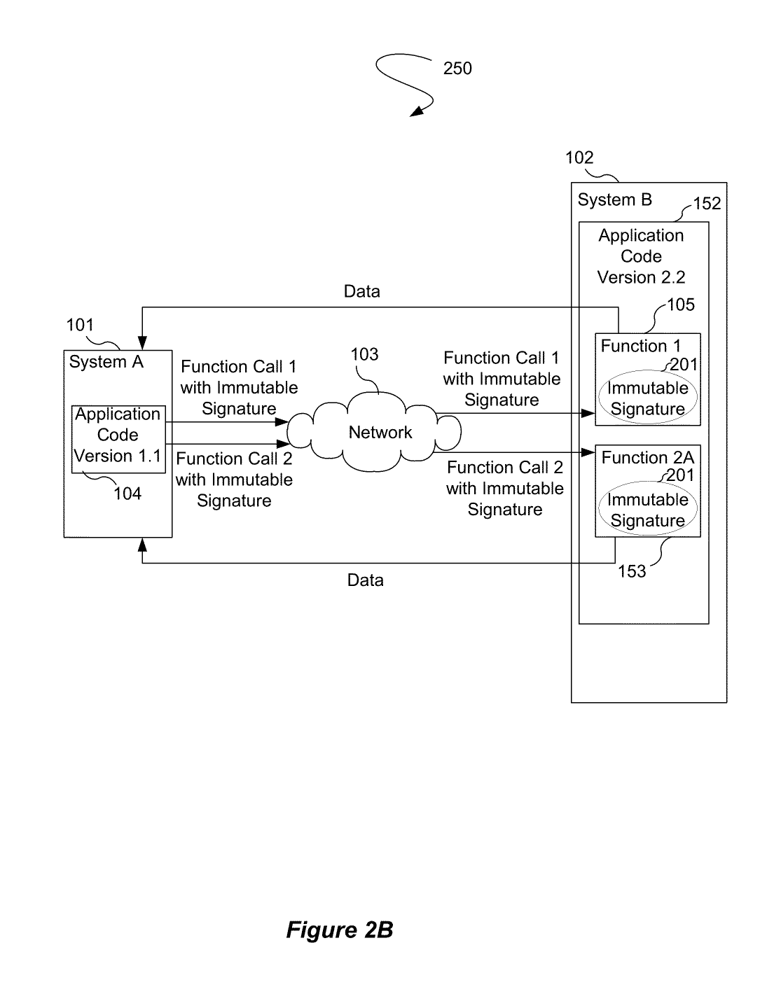

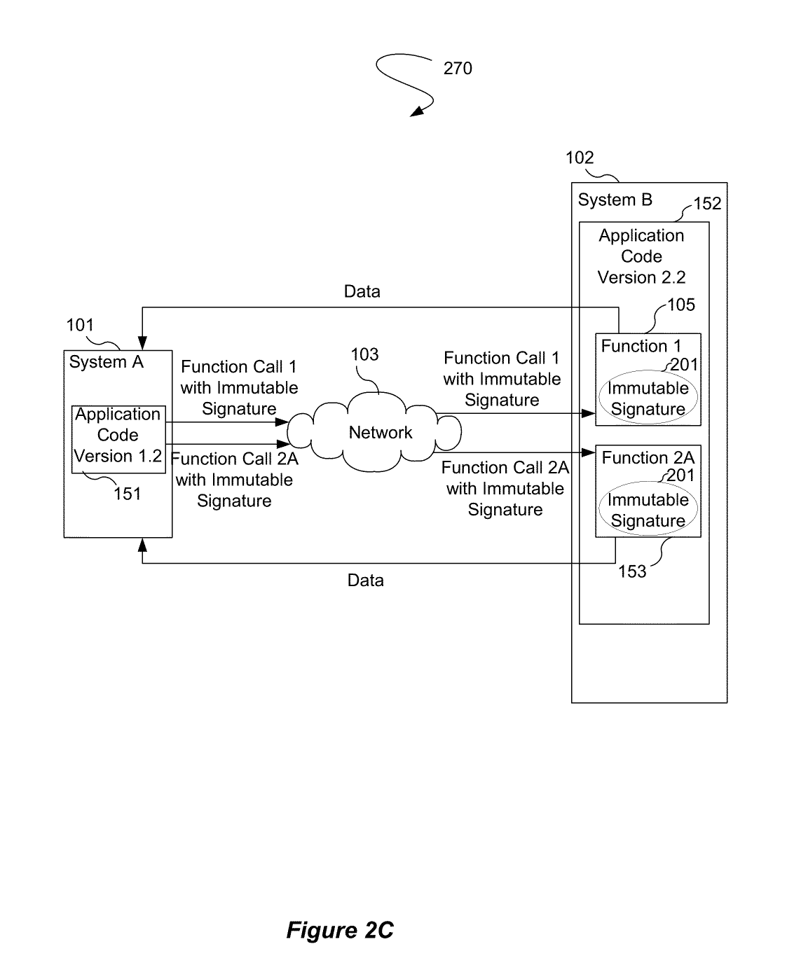

FIGS. 2A, 2B, and 2C illustrate system configurations that utilize an immutable signature. The immutable signature is a single message structure that is utilized for all of the messages sent by systems to and from each other. The immutable signature is predetermined in advance of message transmission and remains unchanged. Therefore, the immutable signature remains unchanged even if a system update is released.

FIG. 2A illustrates an immutable signature configuration 200 prior to a system update. The system A 101 utilizes the application code version 1.1 104 to send function calls through the network 103 to the system B 102. As the system B 102 utilizes the same single immutable signature 201 as the message structure for all of its functions, the system A 101 sends all function calls with a message structure according to that same single immutable signature 201.

FIG. 2B illustrates an immutable signature configuration 250 subsequent to a system update to the system B 102. Although the system B 102 is utilizing the updated application code version 2.2 152, the system A 101 is still able to interact with the system A 101 since the immutable signature has not changed. The immutable signature may still be utilized as the same message structure for the system A 101 to send messages to the system B 102. The system B 102 will understand the messages that are sent by the system A 101 since the messages are still sent according to the same message structure.

The system B 102 may or may not be able to fully perform the requested function if the function has been updated, but will understand the message format since the signature has not changed. For example, the function 2A 153 may be updated in such a manner where a function call to the function 2A 153 may allow the function to be fully or partially performed since the function 2A 153 will receive data according to the same signature as the function 2 106 prior to the system update to the system B 102. Therefore, the immutable signature configuration 200 removes the requirement of previous configurations of a lockstep approach. Code developers may update the system B 102 without having to wait for an update to the system A 101.

FIG. 2C illustrates an immutable signature configuration 270 subsequent to a system update to the system A 101. The system A 101 may be updated to update function names, function parameters, etc. for updated functions provided by the system B 102 so that the system B 102 may fully perform those functions for the system A 101.

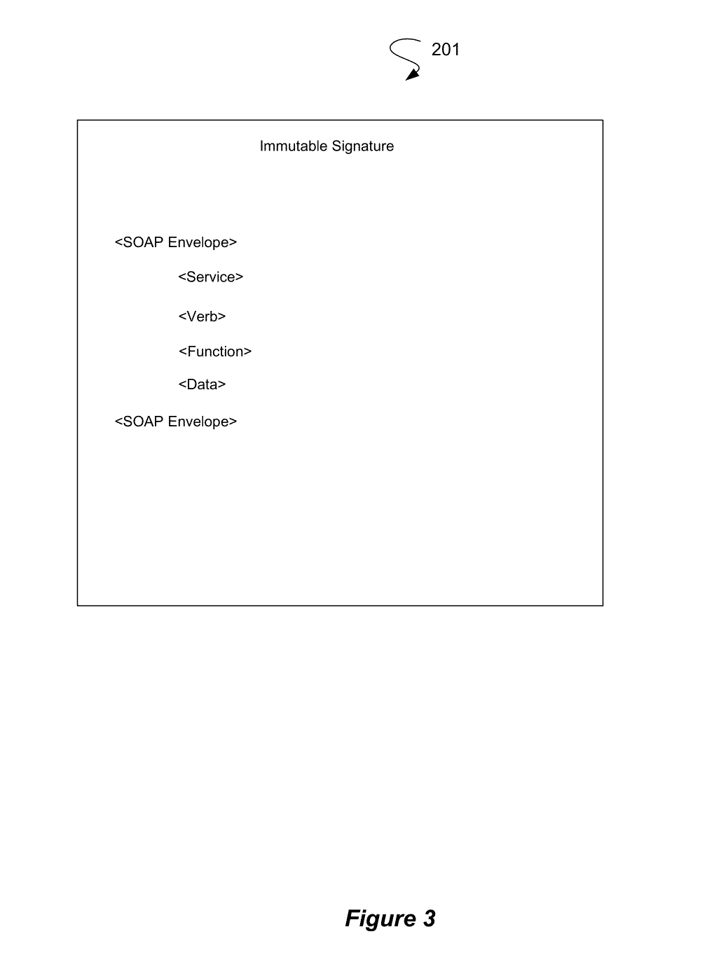

FIG. 3 illustrates an example of the components of an immutable signature 201 illustrated in FIGS. 2A, 2B, and 2C. As an example, a SOAP envelope may be utilized for the immutable signature 201. Protocols other than SOAP may be utilized instead. In one embodiment, the SOAP envelope has the following components: service, verb, function, and data. The same message structure is utilized for all system-to-system interactions, e.g., each message will have the service, verb, function, and data components.

The service component describes where the data is going to be requested from. The verb describes an action that is supposed to be performed by the service. In one embodiment, the verb is selected from the following commands: Create, Read, Update, Delete, and Merge. For instance, a record can be created, read, updated, or deleted. The merge verb allows for the creation of record if the record does not already exist. In one embodiment, the function component is a transactional function or a metadata function. As examples, the transactional function may be an application function (“APF”), a key function (“KEY”), a list function (“LST”), a field validation function (“FVA”), a transaction update function (“TUP”), or a multiple update function (“MUP”). The APF obtains access rights for a service, basic parameters, etc. Further, the KEY obtains one record by primary or business key. In addition, the LST obtains multiple records, e.g., a list of records via query by example. The FVA validates one field, e.g., business rules. Further, the TUP generates or updates one record by utilizing a verb, e.g., create, read, update, delete, or merge. In addition, the MUP generates or updates multiple records by utilizing a verb, e.g., create, read, update, delete, or merge. A security transactional function may also be utilized. The function component may also be a metadata function such as a What is This function (“WIT”) or a Datatype Query (“DTQ”) function. The WIT obtains version data. The DTQ obtains a field list and data types.

The examples of the message components are provided only as examples. Other functions may be utilized. For example, the functions may be read and write. Further, the immutable signature 201 may be utilized with different components. The immutable signature 201 may utilize the data component without other components or in addition to other components.

Utilization of the immutable signature 201 allows for a purposefully restricted dialog between systems. The semantics and the syntax of the immutable signature 201 are immutable so that the same text is utilized to have the same meaning. Therefore, systems are aware of a single immutable message format for communicating with each other.

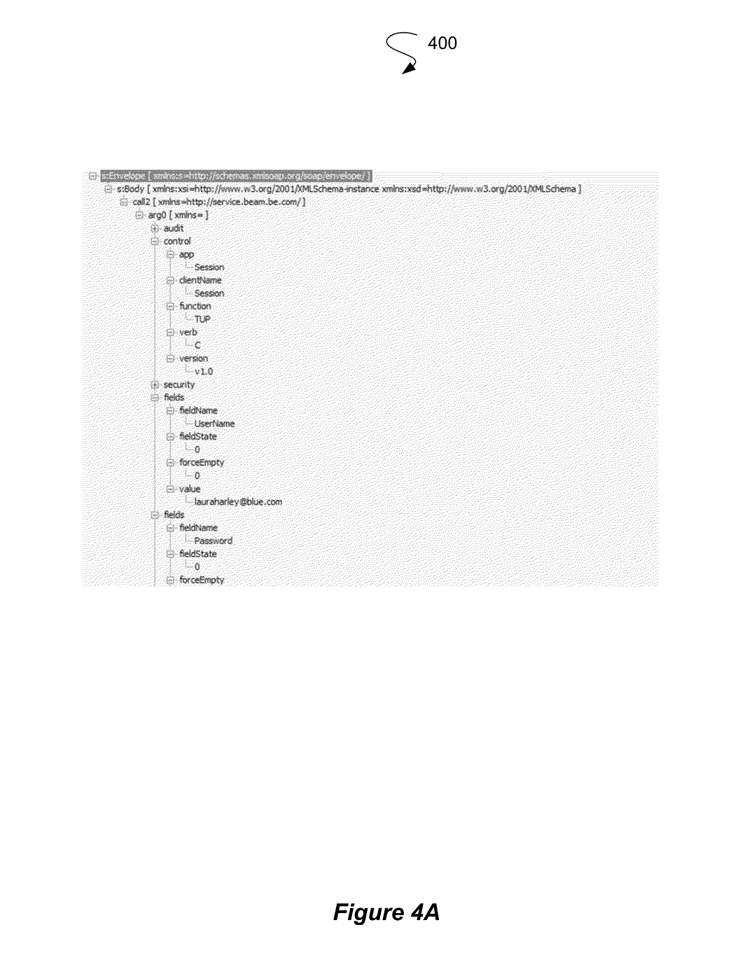

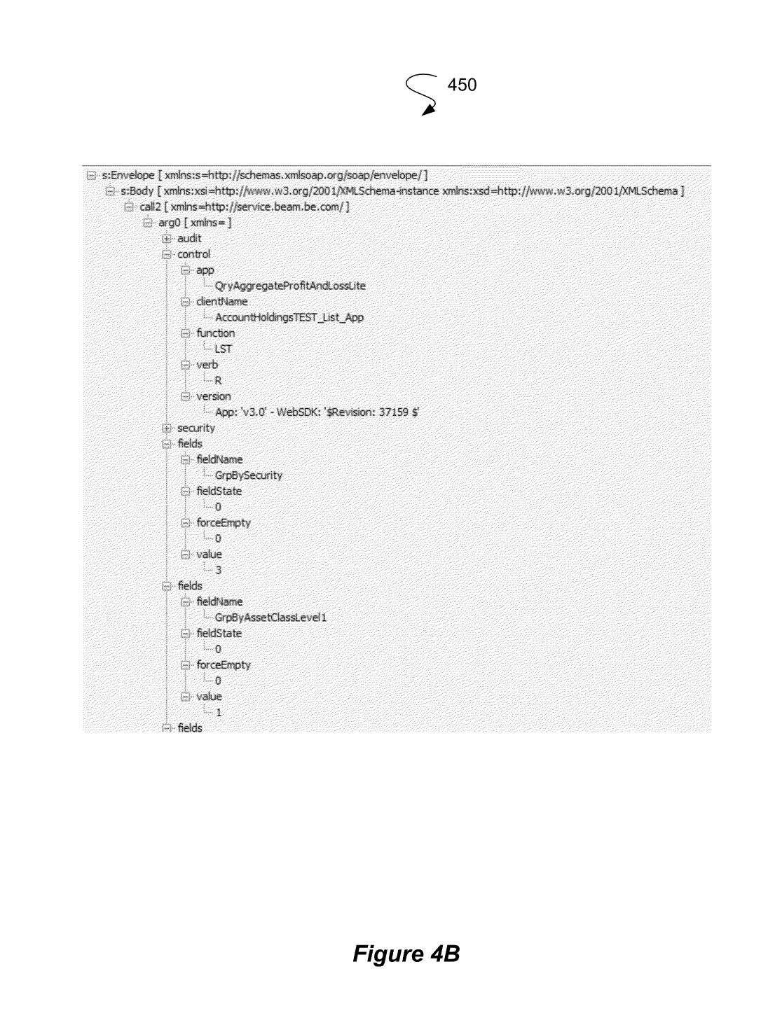

The signature and structure of the message is identical for all messages. The data content can be different for each message. FIGS. 4A and 4B illustrate examples of different messages that have the same signature, but different data content. FIG. 4A is an example of an envelope 400 that is utilized to start a new user session. The structure of the message allows for the selection of a function, e.g., TUP, the selection of a verb, e.g., Create, and various data fields. For example, the system A 101 illustrated in FIGS. 2A, 2B, and 2C may send a message with the envelope 400 to the system B 102 illustrated in FIGS. 2A, 2B, and 2C. The system B 102 may then send data to the system A 101 so that the system A 101 may generate a display screen that displays a request for user login information from a user to start a new user session.

FIG. 4B is an example of an envelope 450 that is utilized to retrieve a list of assets. The structure of the message allows for the selection of a function, e.g., LST, the selection of a verb, e.g., Read, and various data fields. For example, the system A 101 illustrated in FIGS. 2A, 2B, and 2C may send a message with the envelope 450 to the system B 102 illustrated in FIGS. 2A, 2B, and 2C. The system B 102 may then send data to the system A 101 so that the system A 101 may display a list of assets to a user.

The structural layout of the envelope 400 and the structural layout of the envelope 450 are the same, but the data content is different. The data fields and data may differ depending on the particular service that is being requested. Utilization of the same immutable structural layout for all messages avoids a lockstep approach and reduces the amount of resources utilized for code development.

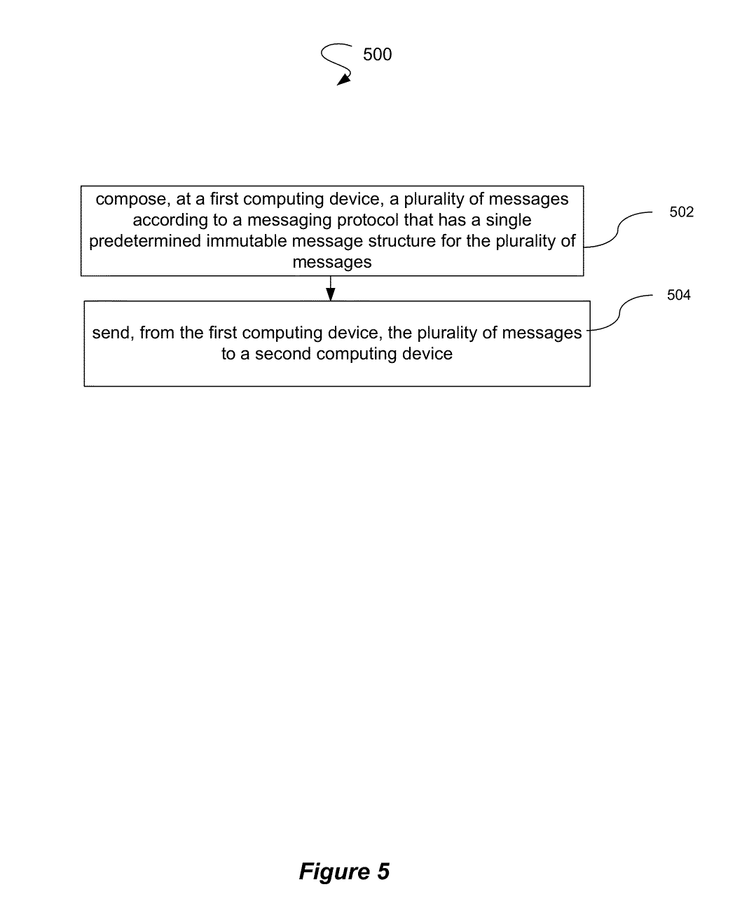

FIG. 5 illustrates a process 500 that may be utilized to generate the immutable signature 201 illustrated in FIGS. 2A, 2B, and 2C. At a process block 502, the process 500 composes, at a first computing device, a plurality of messages according to a messaging protocol that has a single predetermined immutable message structure for the plurality of messages. Further, at a process block 504, the process 500 sends, from the first computing device, the plurality of messages to a second computing device.

The processes described herein may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium. The instructions may also be created using source code, intermediary language or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized data through wireline or wireless transmissions locally or remotely through a network. A computer is herein intended to include any device that has a general, multi-purpose or single purpose processor as described above. The messaging protocol configurations described herein are device-independent as they may be utilized to send and receive messages for a variety of types of computing devices such as personal computers, laptops, tablet devices, smartphones, kiosks, set top boxes, etc.

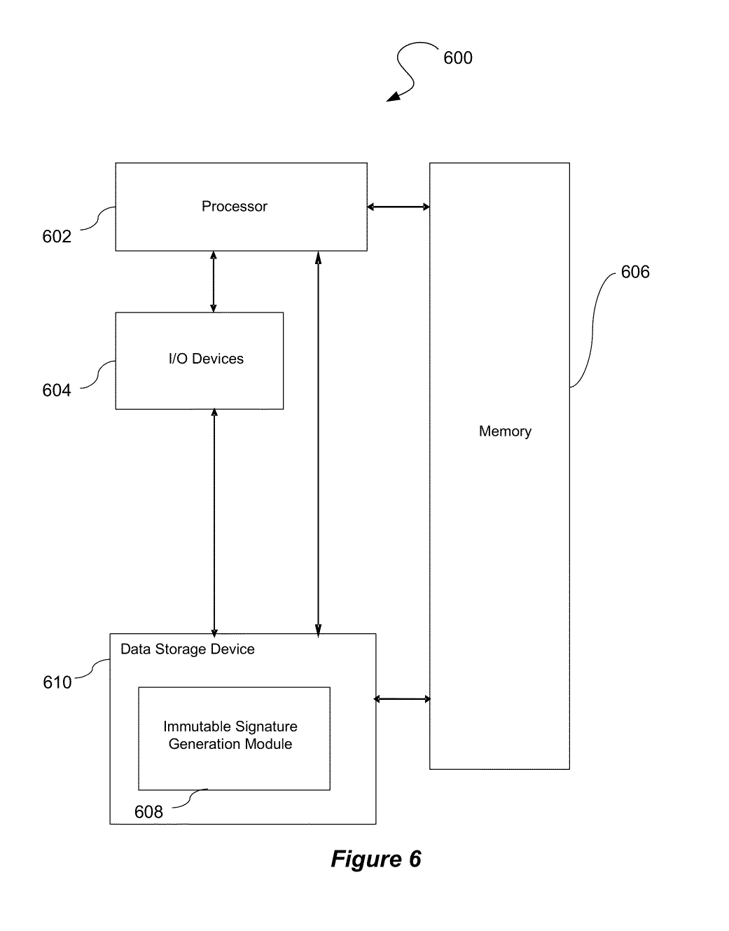

FIG. 6 illustrates a block diagram of a station or system 600 that generates the immutable signature 201 illustrated in FIGS. 2A, 2B, and 2C. In one embodiment, the station or system 600 is implemented utilizing a general purpose computer or any other hardware equivalents. Thus, the station or system 600 comprises a processor 602, a memory 606, e.g., random access memory (“RAM”) and/or read only memory (ROM), an immutable signature generation module 608, a data storage device 610 that stores the immutable signature generation module 608, and various input/output devices 604, e.g., audio/video outputs and audio/video inputs, storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device such as a keyboard, a keypad, a mouse, and the like, or a microphone for capturing speech commands.

It should be understood that the immutable signature generation module 608 may be implemented as one or more physical devices that are coupled to the processor 602. For example, the immutable signature generation module 608 may include a plurality of modules. Alternatively, the immutable signature generation module 608 may be represented by one or more software applications or a combination of software and hardware where the software is loaded from a storage medium such as a storage device, e.g., a magnetic or optical drive, diskette, or non-volatile memory and operated by the processor 602 in the memory 606 of the computer. As such, the immutable signature generation module 608 and associated data structures of the present disclosure may be stored on a computer readable medium such as a computer readable storage device, e.g., RAM memory, magnetic or optical drive or diskette and the like.

The station or system 600 may be utilized to implement any of the configurations. In one embodiment, the immutable signature generation module 608 is integrated as part of the processor 602.

It is understood that the processes, systems, apparatuses, and computer program products described herein may also be applied in other types of processes, systems, apparatuses, and computer program products. Those skilled in the art will appreciate that the various adaptations and modifications of the embodiments of the processes, systems, apparatuses, and computer program products described herein may be configured without departing from the scope and spirit of the present processes and systems. Therefore, it is to be understood that, within the scope of the appended claims, the present processes, systems, apparatuses, and computer program products may be practiced other than as specifically described herein.

We claim:

1. A method comprising:
composing, at a first computing device, a plurality of messages according to a messaging protocol that has a single predetermined immutable message structure for the plurality of messages; and
sending, from the first computing device, the plurality of messages to a second computing device.

2. The method of claim 1, wherein each of the plurality of messages includes a request for data from the second computing device.

3. The method of claim 2, wherein each of the plurality of messages includes a service from which the data is requested.

4. The method of claim 3, wherein each of the plurality of messages includes a verb that specifies an action for the service to perform.

5. The method of claim 4, wherein the verb is selected from the group consisting of: a create command, a read command, an update command, a delete command, and a merge command.

6. The method of claim 4, wherein each of the plurality of messages includes a function that is modified by the verb.

7. The method of claim 6, wherein the function is a transactional function.

8. The method of claim 6, wherein the function is a metadata function.

9. The method of claim 1, wherein the single predetermined immutable message structure is utilized by original code or updated code processed by the first computing device.

10. The method of claim 1, wherein the single predetermined immutable message structure is utilized by original code or updated code processed by the second computing device.

11. A computer program product comprising a computer useable storage device having a computer readable program, wherein the computer readable program when executed on a computer causes the computer to:
compose, at a first computing device, a plurality of messages according to a messaging protocol that has a single predetermined immutable message structure for the plurality of messages; and
send, from the first computing device, the plurality of messages to a second computing device.

12. The computer program product of claim 11, wherein each of the plurality of messages includes a request for data from the second computing device.

13. The computer program product of claim 12, wherein each of the plurality of messages includes a service from which the data is requested.

14. The computer program product of claim 13, wherein each of the plurality of messages includes a verb that specifies an action for the service to perform.

15. The computer program product of claim 14, wherein the verb is selected from the group consisting of: a create command, a read command, an update command, a delete command, and a merge command.

16. The computer program product of claim 14, wherein each of the plurality of messages includes a function that is modified by the verb.

17. The computer program product of claim 16, wherein the function is a transactional function.

18. The computer program product of claim 16, wherein the function is a metadata function.

19. A method comprising:
receiving, at a first computing device, a first plurality of messages according to a messaging protocol that has a single predetermined immutable message structure for the first plurality of messages;
performing a plurality of actions based upon content of the first plurality of messages;
composing, at the first computing device, a plurality of second messages according to the messaging protocol, the plurality of second messages having content associated with the plurality of actions; and
sending, from the first computing device, the plurality of second messages to a second computing device.

20. A system comprising:
a first computing device that composes a first plurality of messages according to a messaging protocol that has a single predetermined immutable message structure for the first plurality of messages and sends the first plurality of messages; and
a second computing device that receives the first plurality of messages, performs a plurality of actions based upon content of the first plurality of messages, composes a plurality of second messages according to the messaging protocol, and sends the plurality of second messages to the first computing device, the plurality of second messages having content associated with the plurality of actions.
